(19) United States
(12) Patent Application Publication
(10) Pub. No.: US 2012/0163236 A1
(43) Pub. Date: Jun. 28, 2012

(54) METHOD OF CHANGING CODEBOOK SETTING INFORMATION FOR INTERCELL INTERFERENCE CONTROL IN MOBILE COMMUNICATION SYSTEM, AND METHOD OF CONTROLLING INTERCELL INTERFERENCE USING THE SAME

(75) Inventors: Kyung Sook KIM, Daejeon (KR); Hyung Sub KIM, Seoul (KR)

(73) Assignee: Electronics and Telecommunications Research Institute, Daejeon (KR)

(21) Appl. No.: 13/335,016

(22) Filed: Dec. 22, 2011

(30) Foreign Application Priority Data
Dec. 23, 2010 (KR) 10-2010-0133311

(51) Int. Cl. H04L 12/28; H04W 72/04

(52) U.S. Cl. 370/254

(57) ABSTRACT

A method of changing codebook configuration stored in user equipment (UE) by a base station includes deciding a PMI to recommend for use in each frequency band available to the UE which is being provided with service from the base station, deciding a PMI to restrict use of for each frequency band available to the UE which is being provided with service from the base station, transmitting PMI coordination information including recommendation coordination type information and PMI information in which the PMI to recommend for use is designated for each corresponding frequency band to the UE, and transmitting PMI coordination information including restriction coordination type information and PMI information in which the PMI to restrict use of is designated for each corresponding frequency band to the UE.

### CLAIM FOR PRIORITY

This application claims priority to Korean Patent Application No. 10-2010-0133311 filed on Dec. 23, 2010 in the Korean Intellectual Property Office (KIPO), the entire contents of which are hereby incorporated by reference.

### BACKGROUND

1. Technical Field

Example embodiments of the present invention relate in general to an intercell interference control technique of a mobile communication system and more specifically to a method of changing codebook subset configuration of user equipment by a base station for intercell interference control in a mobile communication system including a 3GPP Long Term Evolution (LTE)/LTE-Advanced system, and a method of controlling intercell interference using the same.

2. Related Art

In a 3GPP LTE system, user equipment (UE) reports a wideband preferred matrix index (PMI) or subband PMI feedback to a base station based on an antenna transmission mode and codebook subset configuration (codebook subset restriction setting information) which are set through a UE-dedicated radio resource control (RRC) signaling message, and the base station decides downlink transmission precoding based on the PMI feedback information reported by the UE.

FIG. 1 is a diagram illustrating information elements of antenna setting information of each UE defined in the current 3GPP standard specification.

The setting information in FIG. 1 is quoted from the current 3GPP TS 36.331 specification, and is transmitted in a form included in an RRC signaling message which the base station transmits to each UE.

Each bit of the codebook subset restriction information element is mapped with a codebook index, and the UE is restricted to report the PMI only on the codebook index of a bit which is set to “1” in the codebook subset restriction information element. The codebook index is mapped as a precoding matrix defined in 3GPP TS 36.331 and used as a parameter for controlling beamforming. That is, the codebook subset restriction information element is used when the base station sets an available PMI and a non-available PMI to each antenna transmission mode for each UE.

Meanwhile, in the 3GPP LTE-Advanced system, coordinated multipoint transmission (COMP) techniques for intercell interference control have been suggested. In a COMP coordinated scheduling technique, a plurality of adjacent cells exchange resource allocation information, and a resource of each cell is allocated to minimize intercell interference, so that a user's service quality in an edge region between cells is improved. In order to minimize intercell interference in the COMP coordinated scheduling technique, a precoding coordinating technique for controlling beamforming between cells is required.

Thus, there is a need for a method and device that can effectively change codebook subset configuration for intercell interference control.

### SUMMARY

Accordingly, example embodiments of the present invention are provided to substantially obviate one or more problems due to limitations and disadvantages of the related art.

Example embodiments of the present invention provide a method of effectively changing codebook subset configuration, which is capable of supporting precoding coordination between cells so as to minimize intercell interference by improving the conventional art in which PMI feedback is restricted by the codebook subset restriction setting information which user equipment (UE) receives through the UE-dedicated RRC signaling message in a mobile communication system including a 3GPP LTE-Advanced system.

Example embodiments of the present invention provide a method of controlling intercell interference using a method of effectively changing codebook subset configuration, which is capable of supporting precoding coordination between cells so as to minimize intercell interference by improving the conventional art in which PMI feedback is restricted by the codebook subset restriction setting information which UE receives through the UE-dedicated RRC signaling message in a mobile communication system including a 3GPP LTE-Advanced system.

In some example embodiments, a method of changing codebook subset configuration stored in UE according to an instruction from a base station by the UE, includes: receiving precoding matrix index (PMI) coordination information including coordination type information having a recommendation or restriction value and PMI information in which a corresponding PMI is designated by each frequency band available to the UE from the base station; and changing the codebook subset configuration of the UE based on the coordination type information and the PMI information of each frequency band included in the PMI coordination information.

The changing of the codebook subset configuration may include changing the codebook subset configuration of the UE so that a PMI designated by the PMI information of each frequency band is set to a use when the coordination type information has the recommendation value.

The changing of the codebook subset configuration may include changing the codebook subset configuration of the UE so that a PMI designated by the PMI information of each frequency band is set to a use restriction when the coordination type information has the restriction value.

The PMI coordination information may be received through a radio resource control (RRC) broadcast message from the base station.

The codebook subset configuration of the UE may be codebook subset configuration which is present for each frequency band available to the UE.

The codebook subset configuration of each frequency band may follow a codebook subset restriction information element format in which whether or not the corresponding PMI is to use is designated by a value of “1” or “0” for each PMI.

In other example embodiments, a method of changing codebook subset configuration stored in UE by a base station, includes: at the base station, deciding a precoding matrix index (PMI) coordination type; deciding a PMI to recommend for use in each frequency band available to the UE which is being provided with service from the base station when the PMI coordination type is a recommendation coordination type; deciding a PMI to restrict use of for each frequency band available to the UE which is being provided with service from the base station when the PMI coordination type is a restriction coordination type; transmitting PMI coordination information including recommendation coordination type information and PMI information in which the PMI to recommend for use is designated for each corresponding frequency band to the UE when the PMI coordination type is the recommendation coordination type; and transmitting PMI coordination information including restriction coordination type information and PMI information in which the PMI to restrict use of is designated for each corresponding frequency band to the UE when the PMI coordination type is the restriction coordination type.

The deciding of the PMI may be performed by coordination between the base station and an adjacent base station in which intercell interference occurs.

In still other example embodiments, a method of controlling intercell interference by changing codebook subset configuration of UE, includes: deciding, at a base station, a PMI coordination type; deciding a PMI to recommend for use in each frequency band available to UE which is being provided with service from the base station for each UE when the PMI coordination type is a recommendation type; deciding a PMI to restrict use of for each frequency band available to the UE which is being provided with service from the base station for each UE when the PMI coordination type is a restriction type;

transmitting PMI coordination information including recommendation coordination type information and PMI information in which the PMI to recommend for use is designated for each corresponding frequency band to the UE when the PMI coordination type is the recommendation type; transmitting PMI coordination information including restriction coordination type information and PMI information in which the PMI to restrict use of is designated for each corresponding frequency band to the UE when the PMI coordination type is the restriction type; receiving, at the UE, the PMI coordination information including the coordination type information having a recommendation or restriction value and the PMI information in which a corresponding PMI is designated for each frequency band available to the UE from the base station; changing, at the UE, codebook subset configuration of the UE based on the coordination type information and the PMI information of each frequency band included in the PMI coordination information; deciding, at the UE, a PMI of each frequency band or a PMI of a wideband based on the codebook subset configuration and reporting the decided PMI to the base station; and controlling, at the base station, downlink transmission precoding based on the PMI of each frequency band or the PMI of the wideband reported from the UE.

The deciding of the PMI may be performed by coordination between the base station and an adjacent base station in which intercell interference occurs.

### BRIEF DESCRIPTION OF DRAWINGS

Example embodiments of the present invention will become more apparent by describing in detail example embodiments of the present invention with reference to the accompanying drawings, in which:

FIG. 1 is a diagram illustrating information elements of antenna setting information of each user equipment (UE) defined in a current 3GPP standard specification;

FIG. 2 is a flowchart for explaining a method of changing codebook subset configuration of UE by an instruction from a base station according to an embodiment of the present invention;

FIG. 3 is a conceptual diagram illustrating a set of subbands and codebook subset configuration in UE;

FIG. 4 is a conceptual diagram illustrating an example in which codebook subset configuration is changed by a method of changing codebook subset configuration according to the present invention when a coordination type is a recommendation type;

FIG. 5 is a conceptual diagram illustrating an example in which codebook subset configuration is changed by a method of changing codebook subset configuration according to the present invention when a coordination type is a restriction type;

FIG. 6 is a flowchart for explaining a method of changing codebook subset configuration of UE by a base station according to an embodiment of the present invention; and

FIG. 7 is a flowchart for explaining a method of controlling intercell interference based on a method of changing codebook subset configuration according to an embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Hereinafter, exemplary embodiments of the present invention will be described in detail with reference to the accompanying drawings.

A base station sets an available frequency band from an entire bandwidth within a cell for each user equipment (UE), and performs downlink transmission using the set of frequency bands. That is, each UE sets an available frequency band through the RRC signaling message from the base station. The frequency band set for each UE is defined as a set of subbands, and the set of subbands may match with the entire bandwidth. The subband refers to a unit of a frequency band for dividing the entire bandwidth within the base station cell into unit sizes.

In a method of changing codebook subset configuration according to an embodiment of the present invention, the base station transmits PMI coordination information to the UE, and sets a PMI for recommending a use of the available frequency band set for each UE and a PMI for restricting the use of the available frequency band.

The base station transmits the PMI coordination information using an RRC broadcast message. The UE that has received the RRC broadcast message changes the codebook subset restriction setting information in the UE based on the PMI coordination information.

### Method of Changing Codebook Subset Configuration of UE By Instruction From Base Station

FIG. 2 is a flowchart for explaining a method of changing codebook subset configuration of UE by an instruction from the base station according to an embodiment of the present invention.

Referring to FIG. 2, a method of changing codebook subset configuration of UE according to an embodiment of the present invention may include operation S110 of receiving PMI coordination information including coordination type information and PMI information from the base station, and operation S120 of changing codebook subset configuration of the UE based on the coordination type information and the PMI information included in the PMI coordination information. At this time, the PMI coordination information may be received through the RRC broadcast message from the base station.

The PMI coordination information which the UE receives from the base station in operation S110 includes the coordination type and the PMI information of each frequency band.

The coordination type is classified as a recommendation type or a restriction type, and the PMI information of each frequency band is defined by a precoding index of each sub band. The PMI information of each frequency band is processed according to the coordination type.

For example, let us assume that a PMI 5 is designated for a subband #1 by the PMI information of each frequency band. When the coordination type is the recommendation type, the UE that receives service at the frequency band of the subband #1 is requested to use the PMI 5 at the frequency band of the subband #1 for intercell interference control.

However, when the coordination type is the restriction type, the UE that receives service at the frequency band of the subband #1 is requested to restrict a use of the PMI 5 at the frequency band of the subband #1 for intercell interference control.

In operation S120, the UE that has received the PMI coordination information changes the codebook subset configuration of each frequency band stored in the UE. The codebook subset configuration may be configured for each frequency band available to the UE.

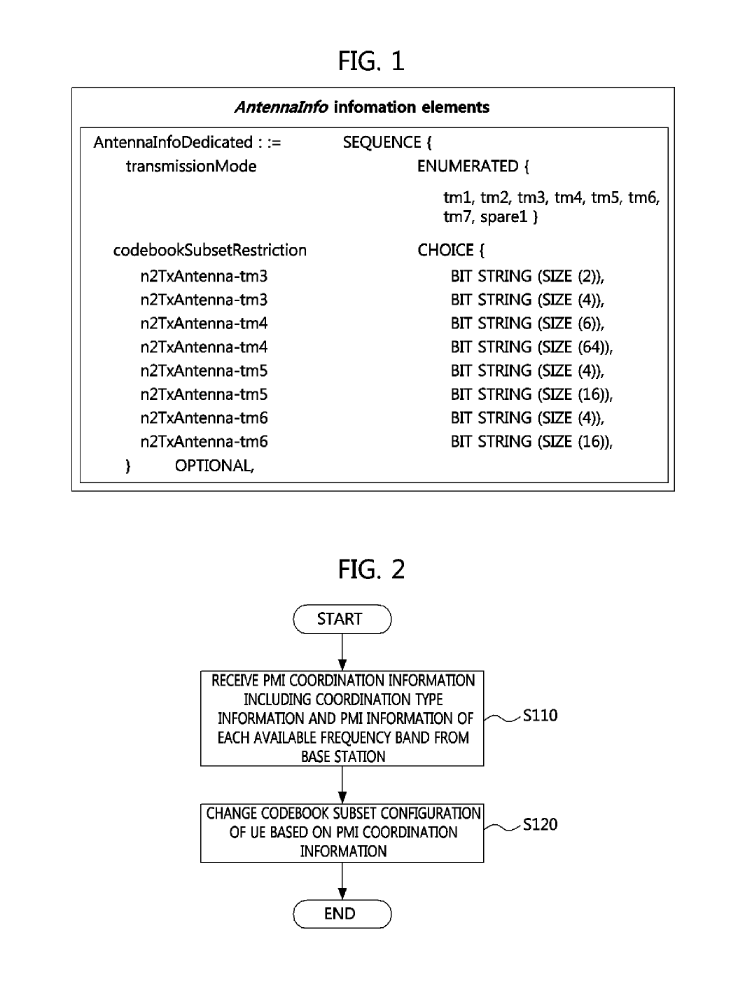

The codebook subset configuration of each frequency band may have a format in which a use of each PMI is designated by a value of “1” or “0.” For example, the codebook subset configuration of each frequency band may be configured according to the format of the codebook subset restriction information element illustrated in FIG. 1.

When the PMI is designated for the frequency band set for each UE by the PMI information of each frequency band, the codebook subset configuration of a corresponding subband is changed according to the coordination type.

For example, when the coordination type is the recommendation type, the UE sets the PMI in the codebook subset restriction information element of the sub band to “1.” However, when the coordination type is the restriction type, the UE sets “0” so as to release the PMI in the codebook subset restriction information element of the sub band.

Next, a description will be made in connection with an example in which the codebook subset configuration of UE is changed by the method of changing the codebook subset configuration according to an embodiment of the present invention.

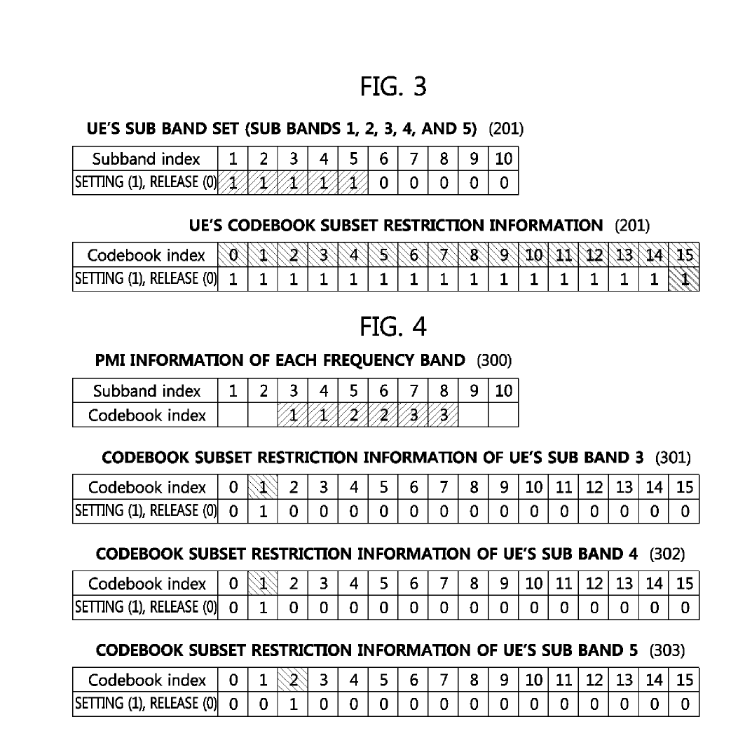

FIG. 3 is a conceptual diagram illustrating a set of subbands and codebook subset configuration in UE.

The UE performs downlink receiving using frequency bands of subbands 1, 2, 3, 4, and 5 based on subband set configuration 201. In codebook subset restriction setting information 202, all of precoding indices 0 to 15 are available on the sub band set. At this time, the UE may select a highest preference among the precoding indices 0 to 15 for the wideband configuring the subband set and then report the wideband PMI feedback using the selected precoding index. Further, the UE may select the highest preference among the precoding indices 0 to 15 for each subband and then report the sub band PMI feedback.

FIG. 4 is a conceptual diagram illustrating an example in which the codebook subset configuration is changed by the method of changing the codebook subset configuration according to the present invention when the coordination type is the recommendation type.

Referring to FIG. 4, in PMI information 300 of each frequency band of the PMI coordination information, PMIs 1, 1, 2, 2, 3, and 3 are designated for sub bands #3, #4, #5, #6, #7, and #8, respectively.

At this time, when the PMI coordination type is the recommendation type, the codebook subset restriction information of the sub bands #3, #4, and #5 set as the subband set of the UE are changed to 301, 302, and 303, respectively, (codebook subset configuration tables for the sub bands #6, #7, and #8 are not shown in FIG. 4).

In the PMI information 300 of each frequency band, the PMI 1 is set to the subband #3 of the subband set 201 set in the UE, and thus the UE sets only the PMI 1 of the subband #3 to “1” (see the table 301). In the PMI information 300 of each frequency band, the PMI 1 is set to the subband #4 of the subband set 201 set in the UE, and thus the UE sets only the PMI 1 of the subband #4 to “1” (see the table 302). In the PMI information 300 of each frequency band, the PMI 2 is set to the subband #5 of the subband set 201 set in the UE, and thus the UE sets only the PMI 2 of the subband #5 to “1” (see the table 303).

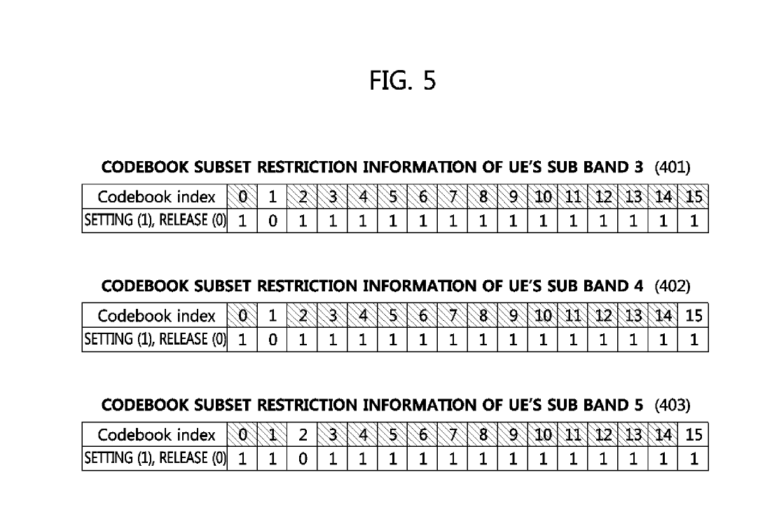

FIG. 5 is a conceptual diagram illustrating an example in which the codebook subset configuration is changed by the method of changing the codebook subset configuration according to the present invention when the coordination type is the restriction type.

Referring to FIG. 5, in PMI information 300 of each frequency band of the PMI coordination information, PMIs 1, 1, 2, 2, 3, and 3 are set to subbands #3, #4, #5, #6, #7, and #8, respectively.

At this time, when the PMI coordination type is the restriction type, the codebook subset restriction information of the subbands #3, #4, and #5 set as the subband set of the UE are changed to 401, 402, and 403, respectively, as illustrated in FIG. 5 (codebook subset configuration tables for the subband #6, #7, and #8 are not shown in FIG. 5).

In the PMI information 300 of each frequency band, the PMI 1 is set to the subband #3 of the subband set 201 set in the UE, and thus the UE sets only the PMI 1 of the subband #3 to “0” (see the table 401). In the PMI information 300 of each frequency band, the PMI 1 is set to the subband #4 of the subband set 201 set in the UE, and thus the UE sets only the PMI 1 of the subband #4 to “0” (see the table 402). In the PMI information 300 of each frequency band, the PMI 2 is set to the subband #5 of the subband set 201 set in the UE, and thus the UE sets only the PMI 2 of the sub band #5 to “0” (see the table 403).

### Method of Changing Codebook Subset Configuration of UE By Base Station

The method of changing the codebook subset configuration of the UE by an instruction from the base station have been described with reference to FIG. 2. Next, a description will be made in connection with a method of changing codebook subset configuration of the UE which is being provided with service by the base station which provides the UE with the service.

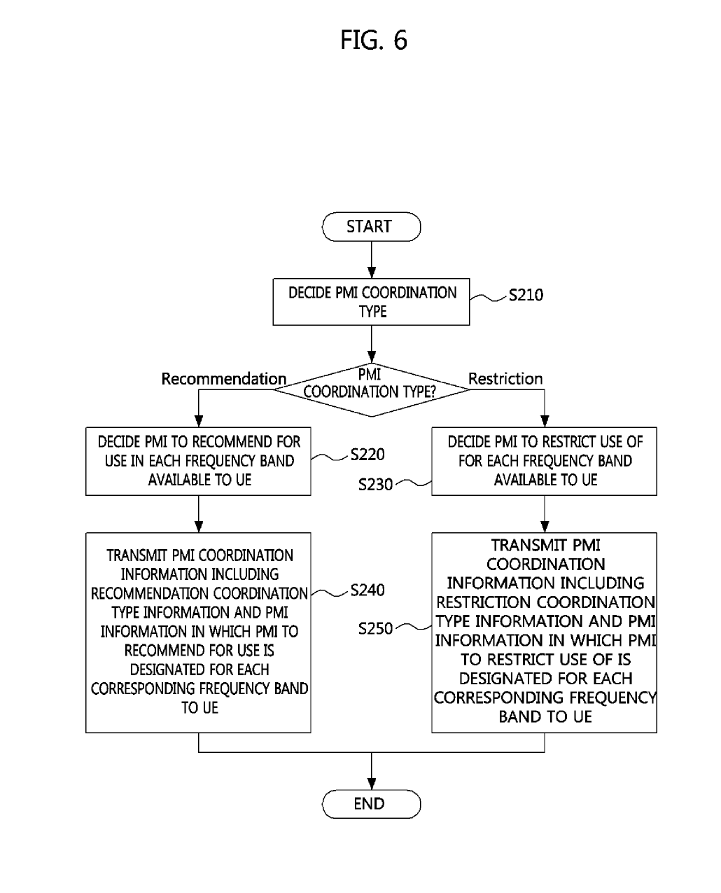

FIG. 6 is a flowchart for explaining a method of changing codebook subset configuration of UE by a base station according to an embodiment of the present invention.

Referring to FIG. 6, a method of changing codebook subset configuration of UE by a base station according to an embodiment of the present invention may include operation S210 of deciding a PMI coordination type by the base station, operation S220 of deciding a PMI to recommend for use in each frequency band available to the UE which is being provided with service from the base station when the PMI coordination type is a recommendation coordination type, operation S230 of deciding a PMI to restrict use of for each frequency band available to the UE which is being provided with service from the base station when the PMI coordination type is a restriction coordination type, operation S240 of transmitting PMI coordination information including recommendation type information and PMI information in which a PMI to recommend for use is designated for each corresponding frequency band to the UE when the PMI coordination type is the recommendation coordination type, and operation S250 of transmitting PMI coordination information including restriction type information and PMI information in which a PMI to restrict use of is designated for each corresponding frequency band to the UE when the PMI coordination type is the restriction coordination type. At this time, the PMI coordination information may be transmitted through the RRC broadcast message from the base station.

A configuration of the PMI coordination information in operations S240 and S250 is the same as the configuration of the PMI coordination information in the method of changing the codebook subset configuration of the UE described with reference to FIG. 2, and thus the redundant description will not be repeated.

Meanwhile, in operation S210, the base station may decide the recommendation type or the restriction type as the PMI coordination type according to a coordination policy between adjacent base stations.

The method of deciding the PMI to recommend for use and the PMI to restrict use of for each frequency band available to the UE in operations S220 and S230 may be performed in various forms. For example, the process of deciding the PMI may be performed by coordination between the base station and an adjacent base station in which intercell interference occurs (for example, information exchange through an X2 interface between base stations).

### Method of Controlling Intercell Interference Based On Codebook Subset Configuration Change According To Present Invention

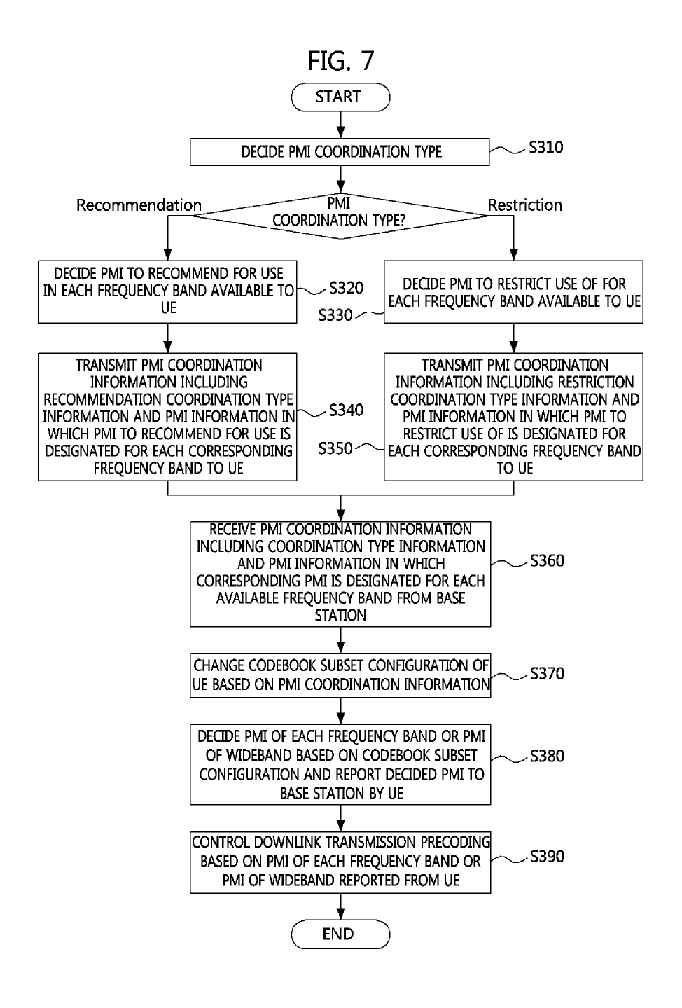

FIG. 7 is a flowchart for explaining a method of controlling intercell interference based on a method of changing codebook subset configuration according to an embodiment of the present invention.

Referring to FIG. 7, the method of controlling intercell interference according to the present invention may include operation S310 of deciding a PMI coordination type by a base station, operation S320 of deciding a PMI to recommend for use in each frequency band available to UE which is being provided with service from the base station for each UE when the PMI coordination type is a recommendation type, operation S330 of deciding a PMI to restrict use of for each frequency band available to UE which is being provided with service from the base station for each UE when the PMI coordination type is a restriction type, operation S340 of transmitting PMI coordination information including recommendation type information and PMI information in which a PMI to recommend for use is designated for each corresponding frequency band to the UE when the PMI coordination type is the recommendation type, operation S350 of transmitting PMI coordination information including restriction type information and PMI information in which a PMI to restrict use of is designated for each corresponding frequency band to the UE when the PMI coordination type is the restriction type, operation S360 of, at the UE, receiving the PMI coordination information including the coordination type information having a recommendation or restriction value and the PMI information in which a corresponding PMI is designated for each frequency band available to the UE from the base station, operation S370 of, at the UE, changing codebook subset configuration of the UE based on the coordination type information and the PMI information of each frequency band included in the PMI coordination information, operation S380 of, at the UE, deciding a PMI of each frequency band or a PMI of the wideband based on the codebook subset configuration, and reporting the decided PMI to the base station, and operation S390 of, at the base station, controlling downlink transmission precoding based on the PMI of each frequency band or the PMI of the wideband reported from the UE.

Operations S310 to S350 correspond to operations S210 to S250 which have been described above with reference to FIG. 6 as an operation of the base station, and operations S360 and S370 correspond to operations S110 and S120 which have been described with reference to FIG. 2 as an operation of the UE, and thus the redundant description will not be repeated.

In operation S380, the UE reports a preference PMI of each frequency band or the wideband to the base station based on the changed codebook subset configuration. That is, after the codebook subset restriction setting information is changed, the UE selects a preferred precoding from precoding indices configured in the PMI information of each frequency band based on the codebook subset restriction setting information, and reports the PMI feedback to the base station. In operation S390, the base station controls intercell interference by controlling downlink transmission precoding based on the PMI feedback information reported from the UE.

That is, intercell interference control is performed such that the UE restricts the PMI feedback report on the precoding set in the PMI information of each frequency band after the codebook subset restriction setting information is changed, and the base station recommends or restricts the use of the precoding index.

For example, referring back to FIG. 4, when the coordination type is the recommendation type, intercell interference can be controlled such that the UE that has changed the codebook subset configuration reports 1, 1, and 2 as the subband PMI feedback on the subbands #3, #4, and #5, or selects and reports the highest preference of the PMIs 1 and 2 as the wideband PMI.

Further, referring back to FIG. 5, when the coordination type is the restriction type, intercell interference can be controlled by restricting the use of the PMIs 1 and 2 such that the UE that has changed the codebook subset configuration selects and reports the highest preference among the PMIs 0 to 15 excluding 1, 1, and 2 as the sub band PMI feedback on the sub bands #3, #4, and #5 and reports the selected one, or selects and reports the highest preference among the PMIs 0 to 15 excluding 1 and 2 as the wideband PMI.

According to the present invention, the conventional technique of changing the codebook subset configuration through the UE-dedicated RRC signaling message by the UE is improved so that the PMI coordination information can be transmitted using the RRC broadcast message. Thus, a plurality of UEs that set the frequency bands needing the PMI coordination as the subband set can effectively change the codebook subset configuration, so that intercell interference can be controlled.

Using a method of changing codebook subset configuration according to the present invention, adjacent cells use an RRC broadcast message so as to coordinate precoding for controlling beamforming between cells in a mobile communication system including a 3GPP LTE-Advanced system, and UE that sets frequency bands needing PMI coordination as a subband set can support intercell interference control by effectively changing codebook subset configuration on the frequency bands.

While the example embodiments of the present invention and their advantages have been described in detail, it should be understood that various changes, substitutions and alterations may be made herein without departing from the scope of the invention.

What is claimed is:

1. A method of changing codebook subset configuration stored in user equipment (UE) according to an instruction from a base station by the UE, comprising:
receiving precoding matrix index (PMI) coordination information including coordination type information having a recommendation or restriction value and PMI information in which a corresponding PMI is designated by each frequency band available to the UE from the base station; and
changing the codebook subset configuration of the UE based on the coordination type information and the PMI information of each frequency band included in the PMI coordination information.

2. The method of claim 1, wherein the changing of the codebook subset configuration includes changing the codebook subset configuration of the UE so that a PMI designated by the PMI information of each frequency band is set to a use when the coordination type information has the recommendation value.

3. The method of claim 1, wherein the changing of the codebook subset configuration includes changing the codebook subset configuration of the UE so that a PMI designated by the PMI information of each frequency band is set to a use restriction when the coordination type information has the restriction value.

4. The method of claim 1, wherein the PMI coordination information is received through a radio resource control (RRC) broadcast message from the base station.

5. The method of claim 1, wherein the codebook subset configuration of the UE is codebook subset configuration which is present for each frequency band available to the UE.

6. The method of claim 3, wherein the codebook subset configuration of each frequency band follows a codebook subset restriction information element format in which whether or not the corresponding PMI is to be used is designated by a value of “1” or “0” for each PMI.

7. A method of changing codebook subset configuration stored in user equipment (UE) by a base station, comprising:
at the base station, deciding a precoding matrix index (PMI) coordination type;
deciding a PMI to recommend for use in each frequency band available to the UE which is being provided with service from the base station when the PMI coordination type is a recommendation coordination type;
deciding a PMI to restrict use of for each frequency band available to the UE which is being provided with service from the base station when the PMI coordination type is a restriction coordination type;
transmitting PMI coordination information including recommendation coordination type information and PMI information in which the PMI to recommend for use is designated for each corresponding frequency band to the UE when the PMI coordination type is the recommendation coordination type; and
transmitting PMI coordination information including restriction coordination type information and PMI information in which the PMI to restrict use of is designated for each corresponding frequency band to the UE when the PMI coordination type is the restriction coordination type.

8. The method of claim 7, wherein the deciding of the PMI is performed by coordination between the base station and an adjacent base station in which intercell interference occurs.

9. The method of claim 7, wherein the PMI coordination information is transmitted through a radio resource control (RRC) broadcast message from the base station.

10. The method of claim 7, wherein the codebook subset configuration stored in the UE is codebook subset configuration which is present for each frequency band available to the UE.

11. The method of claim 10, wherein the codebook subset configuration of each frequency band follows a codebook subset restriction information element format in which whether or not a corresponding PMI is to be used is designated by a value of “1” or “0” for each PMI.

12. A method of controlling intercell interference by changing codebook subset configuration of user equipment (UE), comprising:
deciding, at a base station, a PMI coordination type;
deciding a PMI to recommend for use in each frequency band available to UE which is being provided with service from the base station for each UE when the PMI coordination type is a recommendation type;
deciding a PMI to restrict use of for each frequency band available to the UE which is being provided with service from the base station for each UE when the PMI coordination type is a restriction type;
transmitting PMI coordination information including recommendation coordination type information and PMI information in which the PMI to recommend for use is designated for each corresponding frequency band to the UE when the PMI coordination type is the recommendation type;
transmitting PMI coordination information including restriction coordination type information and PMI information in which the PMI to restrict use of is designated for each corresponding frequency band to the UE when the PMI coordination type is the restriction type;
receiving, at the UE, the PMI coordination information including the coordination type information having a recommendation or restriction value and the PMI information in which a corresponding PMI is designated for each frequency band available to the UE from the base station;
changing, at the UE, codebook subset configuration of the UE based on the coordination type information and the PMI information of each frequency band included in the PMI coordination information;
deciding, at the UE, a PMI of each frequency band or a PMI of a wideband based on the codebook subset configuration and reporting the decided PMI to the base station; and
controlling, at the base station, downlink transmission precoding based on the PMI of each frequency band or the PMI of the wideband reported from the UE.

13. The method of claim 12, wherein the deciding of the PMI is performed by coordination between the base station and an adjacent base station in which intercell interference occurs.

14. The method of claim 12, wherein the PMI coordination information is transmitted to the UE through a radio resource control (RRC) broadcast message from the base station.

15. The method of claim 12, wherein the changing of the codebook subset configuration includes changing the codebook subset configuration of the UE so that a PMI designated by the PMI information of each frequency band is set to a use when the coordination type information has the recommendation value.

16. The method of claim 12, wherein the changing of the codebook subset configuration includes changing the codebook subset configuration of the UE so that a PMI designated by the PMI information of each frequency band is set to a use restriction when the coordination type information has the restriction value.

17. The method of claim 12, wherein the codebook subset configuration of the UE is codebook subset configuration which is present for each frequency band available to the UE.

18. The method of claim 12, wherein the codebook subset configuration of each frequency band follows a codebook subset restriction information element format in which whether or not the corresponding PMI is to be used is designated by a value of “1” or “0” for each PMI.
